(19) United States
(12) Patent Application Publication
(10) Pub. No.: US 2018/0279655 A1
(43) Pub. Date: Oct. 4, 2018

(54) FIBER OBTAINED FROM FRUIT OR VEGETABLE BYPRODUCTS

(71) Applicant: Tropicana Products, Inc., Bradenton, FL (US)

(72) Inventors: Teresa Marie PAESCHKE, St. Louis Park, IL (US); Austin Jon KOZMAN, Dallas, TX (US); Teodoro RIVERA, Algonquin, IL (US); Bryan William HITCHCOCK, New City, NY (US)

(21) Appl. No.: 15/997,055

(22) Filed: Jun. 4, 2018

Related U.S. Application Data
(62) Division of application No. 13/305,360, filed on Nov. 28, 2011, now abandoned.
(60) Provisional application No. 61/418,235, filed on Nov. 30, 2010.

(51) Int. Cl. A23L 2/52; A23L 33/22; A23L 19/00; A23L 2/02

(52) U.S. Cl. CPC A23L 2/52; A23L 33/22; A23L 19/07; A23V 2200/3202; A23L 2/02; A23V 2002/00

(57) ABSTRACT

A fiber extracted from a fruit or vegetable byproduct is provided, the extracted fiber having a molecular weight of between about 5000 grams/mol (g/mol) and about 8000 g/mol, or a pectic oligosaccharide having a molecular weight of between about 300 g/mol and 2500 g/mol. The fiber may be extracted using physical methods or a combination of a physical method to break the fruit or vegetable byproduct cell walls and enzymatic hydrolysis. Also, a comestible containing the extracted fiber is provided. A method for producing a soluble fiber is further provided including reducing the particle size of a fruit or vegetable byproduct, subjecting the byproduct particles to a physical process to break cell walls of the particles, adding one or more enzymes, mixing or agitating the particles, and filtering the byproduct particles to provide a retentate and a permeate. The permeate contains the soluble fiber, which is optionally a prebiotic fiber.

### CROSS-REFERENCE TO RELATED APPLICATIONS

This application claims priority to U.S. Provisional Application Ser. No. 61/418,235 filed on Nov. 30, 2010, which is incorporated herein in its entirety.

### FIELD OF THE INVENTION

This invention relates to fiber that is obtained from byproducts of fruits, vegetables, or combinations thereof. The byproducts may result, for example, from extraction processes for juice from the fruits and vegetables.

### BACKGROUND

Fruits and vegetables have long been recognized as valuable sources of important nutrients. More recently, additional health benefits and disease retarding or treating benefits of fruit and vegetable sources have come to be more fully recognized as advantageous and beneficial when ingested. Finding value in byproduct streams for fruit and/or vegetables, however, is a difficult task despite being investigated by many researchers for various agricultural streams. These attempts have largely been challenged by issues such as difficulty in transporting wet streams to processing facilities, energy costs for drying, solvent recovery, chemical costs, and short harvest periods for seasonal fruit and vegetable byproduct streams.

One potential byproduct is citrus juice solids, which may be obtained from the large volume of citrus peel material which traditionally has been used in low value applications such as livestock feed. Many tons of citrus peel material are collected as a byproduct each citrus harvesting season when juice is extracted from whole citrus fruit by commercial extraction equipment from FMC Corporation, Brown AME and others. In addition to citrus peel, the core, rag, seed, other membranes, pomace, and filtration retentates are also byproducts of citrus juice extraction processes. Such citrus fruits include orange, grapefruit, lime, tangerine and lemon fruits. Heretofore, these peel material resources have been underutilized due to negative characteristics of peels, which characteristics can be considered objectionable on a very wide scale.

Certain approaches have been taken in the past in an effort to process citrus extraction peel byproduct material into products which have a value that is higher than use as livestock feed. Once such approach is that of Bonnell U.S. Pat. No. 4,497,838. This shows a process for recovering “useful” products from orange peels through use of a countercurrent solvent extraction that is carried out with a non-aqueous solvent such as an alcohol. An aqueous extract is collected which contains most of the sugars, essential oils and bioflavanoids from the citrus peel byproduct. A sugar syrup product is said to be produced, as well as an “orange flower” solid product which is high in cellulose and pectin.

Other peel extraction approaches have been suggested. Eschinasi U.S. Pat. No. 4,016,351 shows extracting juice from peel by adding water and calcium to peel prior to pressing the peel in order to form a press cake that is the product of this patent. Calcium is removed with an oxalic acid solution. Gerow U.S. Pat. No. 4,313,372 shows wet pulp/peel being mixed with dilute press liquor and pressed to limit additional press liquor. The wet peel is treated with super heated steam, the material is mixed with lime, and the press cake is dried for collection.

Patist U.S. Pat. Application Publication No. 2006/0204624 shows extracting peel oil from citrus fruit by subjecting a mixture of citrus peel solids and water to high power ultrasonic energy, followed by recovery of the peel oil from the mixture. Khan et al. shows extracting polyphenols from orange peel using ethanol with assistance from ultrasound sonication. (M. K. Khan Abert-Vian, M.; Fabiano-Tixier, A.-S.; Dangles, O.; Chemat, F.; Ultrasound-assisted extraction of polyphenols (flavanone glycosides from orange (Citrus sinensis L.) peel. Food Chemistry, 119, 851-858)

Prior suggested approaches such as these tend to emphasize solvent extraction and chemical processing. They do not disclose the recovery of additional levels of valuable nutrient sources such as low molecular weight fiber from byproduct destined for low-grade livestock feed and transform same into a product suitable for human consumption. There is accordingly a need for approaches which allow a more complete realization of the potential of byproducts from fruits and vegetables.

Another approach to extract nutrients from byproducts is provided in co-owned Chu U.S. Pat. No. 7,485,332, which discloses the extraction of peel juice from citrus peels using water. The extracted peel juice is processed to remove naturally occurring components which detract from the quality of the fruit juice, such as by using an adsorptive resin. The resulting enhanced peel juice comprises water, sugars, flavor components and oils. The extraction of the peel juice, however, is not directed towards breaking open the cell walls of the citrus peel to extract additional nutrients from within the walls.

The subject matter of each patent or publication mentioned herein is incorporated by reference hereinto.

Plant cell walls are typically a complex carbohydrate structure, which contain nutrients within the walls, for example and without limitation, soluble fiber and insoluble fiber. For instance, orange peel is a rich source of fiber and other nutritional components. It comprises approximately 40-50% fiber (dry basis; the water content is about 75%), and about half of the fiber is soluble. The soluble fiber portion contains between 10-15% pectic materials and the rest is thought to be hemicellulose. Soluble fiber is known to be fermentable, meaning that it is not digestible by human enzymes in the stomach or small intestine, but rather utilized by gut bacteria in the large intestine. A few fermentable fibers are classified as prebiotic because they meet specific criteria established by Gibson and Roberfroid (Gibson, G. R. and Roberfroid, M. B., eds. 2008. “Handbook of Prebitoics” CRC Press Taylor & Francis Group. Boca Raton, Fla.). Other fermentable fibers may have prebiotic potential, but lack the substantiation necessary to qualify as prebiotic. Although there is no legal definition for prebiotic by any governing authority at this time, evidence for potential health benefits of soluble fibers is growing rapidly regardless of whether particular fibers qualify or do not qualify as “prebiotic”.

Differences in the structure and composition of soluble fibers result in different fermentation patterns in the colon. The term “fermentation pattern” as used herein refers to short chain fatty acids generated by the metabolism of soluble fiber by gut bacteria, gas production, and an increase in a specific bacterium such as bifidobacterium or lactobacillus in the colon. Through modification of the molecular structure of a fiber using processing techniques, it may be possible to optimize the fermentation pattern to provide a slow fermentation throughout the colon, reducing gas and bloating and increasing the number of beneficial bacteria.

Pectin and hemicellulose have been established as fermentable fibers through experimentation in-vitro and in-vivo. There is also evidence from the literature and from expert analysis that pectic oligosaccharides are an up and coming prebiotic. Pectin as a hydrocolloid is not digestible by monogastric animals, including humans. It passes through the stomach and small intestine, progressing on to the large intestine as a fermentable substrate by colonic bacteria. This has been demonstrated in both animal and human models. Pectin is a highly fermentable substrate, fermenting completely in the colon, unlike other substrates such as cellulose and hemicelluloses. A review of the properties of pectin, both physicochemical as well as fermentability and potential health benefits is available (Endress, Hans Ulrich and Mattes, Frank. 2009. In Fiber ingredients: Food applications and health benefits. Susan Sung Cho and Priscilla Samuels, eds. CRC Press Francis Taylor Group, Boca Raton Fla.).

Early literature from 1977 to 1995 demonstrated colonic fermentation of pectin using both animal and human models (Salyers, A. A., West. S. E. H., Vercelotti, Wilkins, T., 529. Fermentation of mucins and plant polysaccharides by anaerobic bacteria from the human colon. Applied and Environmental Microbiology. 1977: 529-533; Titgemeyer, E. C., Bourquin, L. D., Fahey, G. C., Garleb, K. A. 1991. Fermentability of various fiber sources by human fecal bacteria in vitro. Am J of Clinical Nutr 53: 1418-1424; Bourquin, L. D., Titgemeyer, E. C., Fahey Jr., G. C. 1993 Vegetable fiber fermentation by human fecal bacteria: Cell wall polysaccharide disappearance and short-chain fatty acid production during in vitro fermentation and water-holding capacity of unfermented residues. Journal of Nutr. 123: 860-869; Nicolini, L., Volpe, C., Pezzotti, A., Carilli, A. 1993. Changes in in-vitro digestibility of orange peels and distillery grape stalks after solid-state fermentation by higher fungi. Bioresource Technology 45(1): 17-20; Roth, J. A., Frankel, W. L., Zhang, W., Klurfeld, D. M., Rombeau, J. L. 1995 Pectin improves colonic function in rat short bowel syndrome. Journal of surgical research 58: 240-246; Sunvold, G. D., Hussein, H. S., G. C. Fahey, Jr., Merchane, N. R., and Reinhart, G. A. 1995. In vitro fermentation of cellulose, beet pulp, citrus pulp, and citrus pectin using fecal inoculums from cats, dogs, horses, humans, and pigs, and ruminal fluid from cattle. J Anim Scie 1995. 73:3639-3648). Pectin from different fruits and vegetable sources has considerable structural (e.g., branching versus linear) and compositional (e.g., monosaccharide content) diversity (Fishman, M. L., El-Atawy, Y. S., Sondey, S. M., Gillespie, D. T., Hicks, K. B. 1991. Component and global average radii of gyration of pectins from various sources). For example, sugar beet pectin is highly branched while commercial citrus pectins are more linear in structure.

A highly branched pectin does not form gels as well as one with a more linear structure, due at least to steric hindrance and availability of binding sites. Differences in fermentation patterns have been demonstrated based on these structural differences (Gulfi, M., Arrigoni, E., Amando, R. 2005. Influence of structure on in vitro fermentability of commercial pectins and partially hydrolysed pectin preparations. Carbohydrate Polymers 59:247-255; Gulfi, M., Arrigoni, E., Amado, R. 2006. The chemical characteristics of apple pectin influence its fermentability in vitro. LWT 39: 1001-1004; Gulfi, M., Arrigoni E., Amado, R. 2007. In vitro fermentability of a pectin fraction rich in hairy regions. Carbohydrate Polymers, 67: 410-416). It has also been shown that the degree of methylation has an impact on fermentation patterns, by comparing low methoxy versus high methoxy pectins (Dongowski, G., Lorenz, A., Proll, J. 2002. The degree of methylation influences the degradation of pectin in the intestinal tract of rats and in vivo. J. Nutr. 132: 1935-1944). It is not clear what pectic structures would be more desirable for optimal fermentation pattern in the colon.

The term “fermentability” is defined herein as carbohydrates or other substances that are utilized by gut bacteria as energy sources in the large intestine as a result of not being digestible by alimentary enzymes. The main products of fermentation are the short chain fatty acids (SCFAs) acetate, proprionate, butyrate and to a lesser extent lactic, valeric, isovaleric, and isobutyric. Fermentation is also responsible for the production of gas and flatulence, including hydrogen, carbon dioxide, and methane.

The term “prebiotic” does have a specific definition in the art and is accepted by some authorities, but not others. The definition was first proposed and defined by Gibson et al. (Gibson, G. R. and Roberfroid, M. B. 1995. Dietary modulation of the colonic microbiota: Introducing the concept of prebiotics. J. Nutr. 125: 1401-1412), and then revised over the years to the current definition, which is as follows: resistance to digestive processes in the upper GI tract, fermentation by intestinal microbiota, and selective stimulation, growth and/or activity of a limited number of the health promoting bacteria in the microflora. The term “prebiotic” as used herein has the same meaning as the definition by Roberfroid and Gibson. According to Roberfroid and Gibson, there are only 3 prebiotic substances with enough substantiation to meet the above criteria: inulin/FOS, trans-galacto-oligosaccharides, and lactulose. There is some disagreement among those of skill in the art with the definition of Roberfroid and Gibson, however. In addition, there are no FDA guidelines regarding making a label claim for prebiotics at the current time.

It has been clearly demonstrated that prebiotics increase both: (1) Bifidobacteria and Lactobacillus populations in the colon and (2) Short chain fatty acid (SCFA) and other metabolites through bacterial fermentation in the colon. It remains unclear at this point how prebiotics impact health and what the health benefits are of consuming various fermentable fibers. Very little research has been conducted to understand carbohydrate structure (e.g., the bonding arrangement) and which bacteria metabolize particular structures or how the bacteria metabolize the structures.

Pectin as a hydrocolloid is usually not consumed at high enough levels to impact gut health to a great extent, possibly because the high molecular weight of pectin results in undesirably high viscosity in comestible products even at low levels. Some researchers have investigated enzymatically modifying higher molecular weight polysaccharide through hydrolysis to lower molecular weight oligosaccharides with lower viscosity (Olano-Martin et al., 2002, Manderson, et al., 2005, Van Den Broek et al., 2008, Hotchkiss et al., 2009, Yamada et al., 2009).

Further experimentation with low molecular weight fiber in human fecal fermentation trials has shown potential of the fiber as an ingredient for gut health. Manderson et al. used pectinases with citrus peel from early Hamlin oranges to create pectic oligosaccharides with a degree of polymerization (DP) of 3-15, using chemical treatment of the peels during extraction of the pectin (Manderson, K., Pinart, M., Tuohy, K. M., Grace, W. E., Hotchkiss, A. T., Widmer, W., Yadhav, M. P., Gibson, G. R., Rastall, R. A. 2005. In vitro determination of prebiotic potential of oligosaccharides derived from an orange juice manufacturing by-product stream. Applied and environmental microbiology. 71(12):8383-8389). Fermentability or prebiotic characteristics can potentially be optimized by altering structure and molecular weight, both of which may be accomplished through enzymes and other processing techniques.

The other half of the soluble fiber portion in orange peel is generally believed to be hemicellulosic in nature. Hemicellulose is a very complex hetero polymer and includes arabinoxylan, glucuronoxylan, glucomannans, and xyloglucans, among other polymers. Hemicellulose analyzes as fiber through current AOAC International methods as either soluble or insoluble fiber, depending on how tightly it is bound to cellulose or other cell wall material, such as being bound by ferulic acid esters. Hemicelluloses from grain sources have been investigated by a number of researchers as fermentable and possibly prebiotic substrates, such as showing prebiotic potential for wheat arabinoxylans (Grootaert, C., Delcour, J., Courtin, C. M., Broekaert, W. F., Verstraete, W., Vand de Wiele. 2007. Microbial metabolism and prebiotic potency of arabinoxylan oligosaccharides in the human intestine. Trends in Food Science and Technology. 18(2): 64-71). Little is known about the structure of hemicelluloses in particular fruits and vegetables, and the fermentability of hemicelluloses is not well defined at this time.

Although there is literature demonstrating the fermentability of both pectin and pectic oligosaccharides, the use of fruit or vegetable byproducts as a source of low viscosity fermentable fiber has not been disclosed.

### SUMMARY

One advantage of embodiments of the present invention is the extraction and modification of pectin and hemicellulose from fruit or vegetable byproducts to result in low viscosity fiber, prebiotic fiber, or combinations thereof, by breaking apart and modifying plant cell wall material. A further advantage of embodiments of the present invention is the acquisition of fiber from such byproducts employing only physical and optionally also enzymatic processes, and without employing chemical modification processes.

In accordance with one aspect, a low molecular weight fiber is provided comprising a fiber extracted from a fruit or vegetable byproduct, comprising a molecular weight of between about 5000 grams/mol (g/mol) and about 8000 g/mol. The fiber is extracted using at least one physical method or a combination of a physical method to break the byproduct cell walls and enzymatic hydrolysis. Alternatively, the fiber is a pectic oligosaccharide comprising a molecular weight of between about 300 g/mol and about 2500 g/mol.

In accordance with another aspect, a method is provided comprising reducing the particle size of a fruit or vegetable byproduct, combining the byproduct particles with a liquid to form a slurry, optionally heating the slurry to deactivate enzymes present in the byproduct particles, optionally cooling the slurry, subjecting the slurry to a physical process to break cell walls of the byproduct particles, adding one or more enzymes to the slurry, mixing or agitating the slurry, and filtering the slurry to provide a retentate and a permeate. The permeate contains soluble fiber, which is optionally a prebiotic fiber.

In accordance with yet another aspect, a method is provided comprising reducing the particle size of a fruit or vegetable byproduct, optionally heating the fruit or vegetable byproduct particles to deactivate enzymes present in the byproduct particles, optionally cooling the byproduct particles, subjecting the byproduct particles to a physical process to break cell walls of the particles, adding one or more enzymes to the byproduct particles, mixing or agitating the byproduct particles, and filtering the byproduct particles to provide a retentate and a permeate. The permeate contains soluble fiber, which is optionally a prebiotic fiber.

In accordance with a further aspect, a comestible is provided comprising a low molecular weight or pectic oligosaccharide fiber extracted from a fruit or vegetable byproduct, wherein the fiber is extracted using at least one physical process or a combination of a physical process and enzymatic hydrolysis of the fruit or vegetable byproduct.

It will be appreciated by those skilled in the art, given the benefit of the following description of certain exemplary embodiments of the methods and products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### BRIEF DESCRIPTION OF THE FIGURES

FIG. 1a is a flow chart of a process for obtaining fiber from fruit or vegetable byproduct, according to an embodiment of the invention.

FIG. 1b is a flow chart of a process for obtaining fiber from fruit or vegetable byproduct, according to an alternate embodiment of the invention.

FIG. 2 is a diagram of an apparatus for obtaining fiber from fruit or vegetable byproduct, according to an embodiment of the invention.

FIG. 3 is graph of soluble fiber and insoluble fiber extracted from citrus peels according to an embodiment of the invention.

FIG. 4 is a graph of soluble fiber and insoluble fiber extracted from citrus peels according to an alternate embodiment of the invention.

FIG. 5 is a graph of measured viscosity of extracts from citrus peels, according to embodiments of the invention.

### DETAILED DESCRIPTION OF EMBODIMENTS

It is an advantage of the invention to provide methods for breaking apart plant cell walls of fruit or vegetable byproducts and extracting nutrients from within the plant cells. It is an advantage of at least certain embodiments of the invention to modify nutrients extracted from the byproducts to selectively produce fiber components, for example and without limitation, polysaccharides, oligosaccharides, low molecular weight fiber, prebiotic fiber, and combinations thereof. It is a further advantage of the invention to provide food and beverage products having desirable appearance, taste and health properties. It is an advantage of at least certain embodiments of the invention to provide food or beverage products having increased fiber content. It is a still further advantage of the invention to make use of nutrients obtained from fruit or vegetable processing, which might otherwise be discarded as waste byproducts. These and other advantages and features of the invention or of certain embodiments of the invention will be apparent to those skilled in the art from the following disclosure and description of exemplary embodiments.

As noted above, it is an advantage of the invention to provide methods for breaking apart plant cell walls of fruit or vegetable byproducts and extracting nutrients from within the plant cells. As used herein, the term “byproduct” is defined as any edible part that is normally extracted from a fruit or vegetable and typically discarded during processing of the fruit or vegetable. The processing may comprise juice extraction, juice processing (e.g., solids removed during clarification of a juice), removal of parts that provide negative characteristics (e.g. undesirable taste, texture, appearance, and the like), and combinations thereof. The byproducts may be, for example and without limitation, peel, core, rag, seeds, rind, pomace, sensible solids, sinking solids, vesicles, finisher-derived solids, pulp, sacs, pericarp, membranes, cellulosic materials, homogenized pulp, pith, pips, albedo, flavedo, and combinations thereof.

The term “finisher-derived solids” as used herein refers collectively to solids removed from juice that has been extracted from fruits and/or vegetables. Such solids may include, without limitation, material from peel, seeds, membranes, cellulosic materials and sensible pulp such as bitable fruit pulp, fruit vesicles, and/or fruit sac, which are typically removed from the juice in a finishing step, depending on the specific type of fruit or vegetable.

The source of the particular fruit or vegetable byproduct is not limited, and may include for example and without limitation, one or more byproducts selected from the following: orange, lemon, lime, tangerine, mandarin orange, tangelo, pomelo, grapefruit, grape, red grape, sweet potato, tomato, celery, beet, lettuce, spinach, cabbage, artichoke, broccoli, brussels sprouts, cauliflower, watercress, peas, beans, lentils, asparagus, onions, leeks, kohlrabi, radish, turnip, rutabaga, rhubarb, carrot, cucumber, zucchini, eggplant, raisin, cranberry, pineapple, peach, banana, apple, pear, guava, apricot, watermelon, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, lychee, plum, prune, date, currant, cashew apple, fig, or combinations thereof. Numerous additional and alternative liquids fruits or vegetables suitable for use in at least certain exemplary embodiments will be apparent to those skilled in the art given the benefit of this disclosure.

The specific nutrients that may be derived from fruit or vegetable byproducts will depend on the particular fruit or vegetable as well as the portion of the fruit or vegetable from which the byproduct is obtained. Examples of nutrients that may be extracted from fruit and vegetable byproducts includes, without limitation, soluble fiber, insoluble fiber, pectin, cellulose, hemicellulose, vitamins, minerals, monosaccharides, disaccharides, oligosaccharides, polysaccharides, oils, phytonutrients (e.g., flavonoids and other bioactive components), and combinations thereof.

For instance, a typical orange peel stream may comprise between about 40% by weight and about 50% by weight fiber, of which almost half of the fiber is soluble fiber. Additionally, the potential exists to transform some of the insoluble fiber into soluble fiber with processing techniques. Soluble fiber is desirable as a fermentable and possibly prebiotic fiber with multiple potential health benefits. About 10% by weight to about 15% by weight of the stream is pectin, which, as discussed above, is a bioactive molecule. Orange peel further comprises components such as water, flavors, sugars, oils and flavonoids. Such components include flavonoids such as the flavones hesperidin (typically present in orange juice at 350-7000 mg/liter), hesperidin glucoside, narirutin (typically present in orange juice at 18-65 mg/liter) narirutin glucoside, eriodictoyl, taxifolin, naringenin, isosakuranetin, and the like. Also included are carotenoids and polyphenolic compounds such as para-vinylguaiacol (PVG).

To derive as much of the nutrients from fruit or vegetable byproducts as possible, it is beneficial to break the plant cell walls, thereby releasing nutritional components from within the cells of the fruit or vegetable byproduct. Suitable methods for breaking cell walls include physical methods, for example and without limitation, cutting, shredding, slicing, grinding, shearing, extruding, homogenizing, pulverizing, comminuting, subjecting to cavitation, pressurizing, heating, pressing, freezing, distilling, evaporating, crystallizing, filtering, subjecting to pulsed electric field processing, and combinations thereof. Moreover, subjecting to cavitation includes, for example and without limitation, subjecting to cavitation via ultrasonic frequency, vacuum cycle nucleation, hydrodynamic cavitation, cavitation via an external transducer, and combinations thereof.

The application of cavitation, such as via ultrasonic frequency, to a liquid composition comprising plant cells generates cavitation bubbles, which subject the liquid to high shear forces and energy waves upon collapse of the cavitation bubbles. The liquid is driven to penetrate the porous plant cell walls by this energy. Once the liquid is disposed within the plant cell walls, it may support cavitation that further opens the plant cell wall pores and thereby enhances extraction of components from within the plant cells, such as low molecular weight components. Moreover, at high energy levels, subjection to ultrasonic frequency may also fracture the plant cell walls to release cellular material and provide plant cell wall fragments. The cavitation via ultrasonic frequency may be employed at a range of amplitudes, for example and without limitation, between about 5 microns and about 150 microns. The same general principles apply to cavitation via an external transducer, cavitation via vacuum cycle nucleation, and to hydrodynamic cavitation. For instance, cavitation via an external transducer comprises a device disposed on an exterior surface of the reaction equipment, which converts energy and generates cavitation bubbles within a liquid composition present inside of the reaction equipment. Vacuum cycle nucleation comprises alternating positive and negative pressure levels within a liquid composition to generate cavitation. Hydrodynamic cavitation comprises the use of low pressure to vaporize liquid in a liquid composition, thereby forming cavities that implode due to the high pressure surrounding them.

It was discovered that certain processes and combinations of processes result in the generation of pectic oligosaccharides, low molecular weight fiber, or combinations thereof from fruit or vegetable byproducts. In certain embodiments of the invention, once the one or more nutrients have been extracted from the fruit or vegetable byproducts, modification of the nutrients may be performed. For instance, insoluble fiber and other high molecular weight fiber are optionally subjected to hydrolysis to reduce the size of the fiber molecules. One method for hydrolyzing the fiber comprises employing enzymes, for example and without limitation, a cellulase enzyme, a pectinase enzyme, a hemicellulase enzyme, an endocellulase enzyme, an exocellulase enzyme, a cellobiase enzyme, a cellulose phosphorylase enzyme, an enzyme from the Lyases family, or combinations thereof.

In certain aspects of the invention, such hydrolysis increases the ratio of soluble fiber to insoluble fiber in the extract. In embodiments of the invention, enzymatic hydrolysis provides prebiotic fiber, such as pectic oligosaccharides or other low molecular weight fiber. Surprisingly, a combination of enzymatic hydrolysis and physical breaking of cell walls is capable of providing soluble fiber having a targeted molecular weight range. This is unexpected at least because certain physical processes tend to deactivate enzymes, however a combination of cavitation via ultrasound, enzyme hydrolysis, heat, and pressure successfully extracted fiber from within fruit byproduct cell walls and decreased the molecular weight of the fiber.

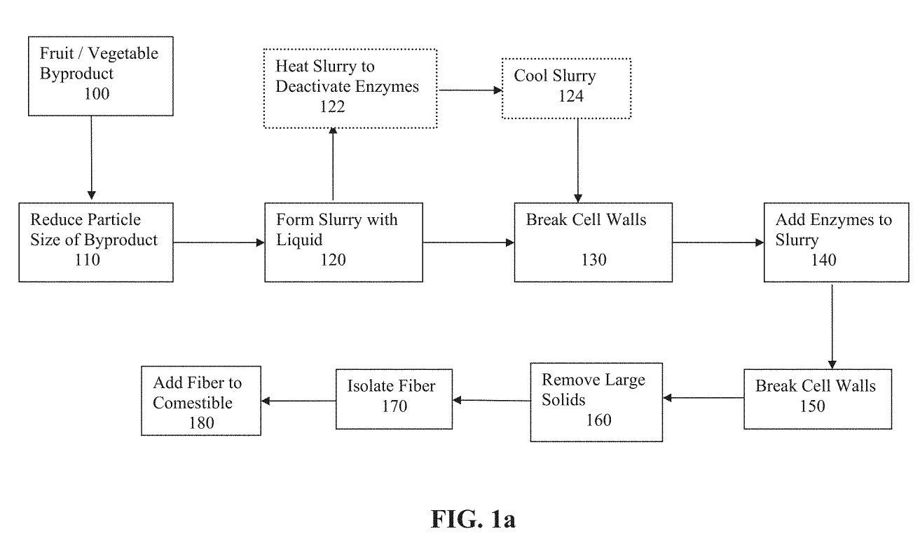

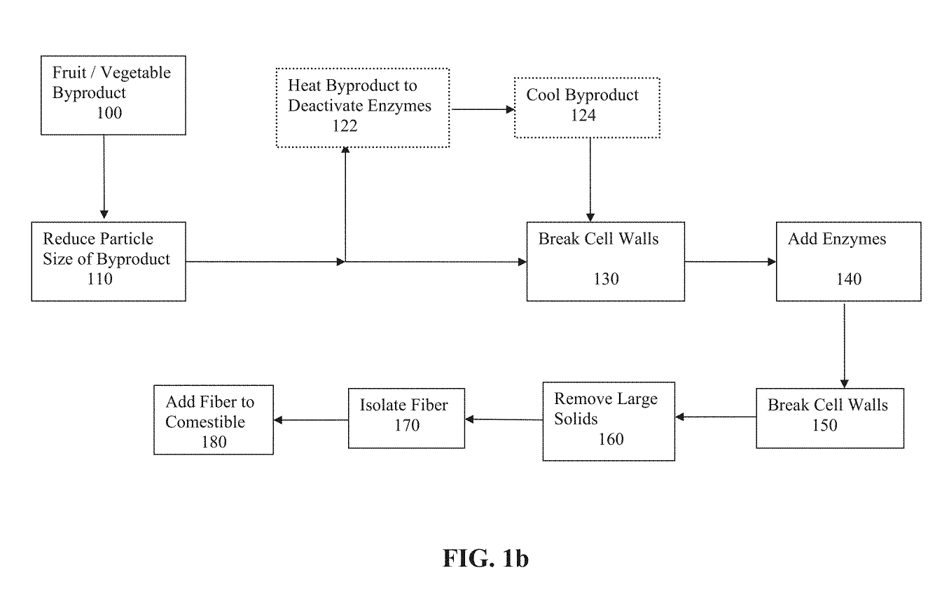

Referring to the Figures, in which like numbers refer to like elements, FIG. 1a provides a flow chart with a general process for deriving nutrients from a fruit or vegetable byproduct, according to certain embodiments of the invention. Such a general process typically comprises providing a fruit and/or vegetable byproduct 100, reducing the particle size of the byproduct 110 to increase the surface area to be extracted, combining the byproduct particles with a liquid, for example and without limitation, water, fruit juice, vegetable juice, or combinations thereof, to form a slurry 120, optionally deactivating naturally-occurring enzymes in the byproduct by heating the slurry 122 followed by cooling the slurry 124, breaking cell walls of the fruit and/or vegetable byproduct particles 130 by employing at least one physical process to increase the surface area on the particles, and adding one or more selected enzymes to the slurry 140. Next, again breaking cell walls of the fruit and/or vegetable byproduct particles 150 by employing at least one physical process, followed by removing large solids 160 and isolating the modified fiber 170. The isolated fiber, and optionally one or more other extracted nutrients, are then included in a comestible 180 to increase the nutrition of the comestible.

FIG. 1b provides a flow chart with an alternate general process for deriving nutrients from a fruit or vegetable byproduct, according to certain embodiments of the invention. Such a general process typically comprises providing a fruit and/or vegetable byproduct 100, reducing the particle size of the byproduct 110 to increase the surface area to be extracted, optionally deactivating naturally-occurring enzymes in the byproduct by heating 122 the byproduct particles followed by cooling 124, breaking cell walls of the fruit and/or vegetable byproduct particles 130 by employing at least one physical process to increase the surface area on the particles, and adding one or more selected enzymes 140. Next, again breaking cell walls of the fruit and/or vegetable byproduct particles 150 by employing at least one physical process, followed by removing large solids 160 and isolating the modified fiber 170. The isolated fiber, and optionally one or more other extracted nutrients, are then included in a comestible 180 to increase the nutrition of the comestible. According to embodiments of this method, it is not necessary to add a liquid to form a slurry as the fruit or vegetable byproduct comprises sufficient liquid for the physical process and enzyme processes to be performed. Moreover, when the byproduct particles of certain fruit and vegetable byproducts are subjected to a physical process to break cell walls of the particles additional liquid is released thereby forming a slurry.

According to certain embodiments of the invention, nutrients are derived from a fruit or vegetable byproduct by employing only one or more physical processes, namely by breaking the plant cell walls, thereby releasing nutritional components from within the cells of the fruit or vegetable byproduct. Suitable physical methods include, for example and without limitation, cutting, shredding, slicing, grinding, shearing, extruding, homogenizing, pulverizing, comminuting, subjecting to cavitation, pressurizing, heating, pressing, freezing, distilling, evaporating, crystallizing, filtering, subjecting to pulsed electric field processing, and combinations thereof. Subjection of fruit or vegetable byproducts to certain one or more of the above-listed processes, in certain embodiments, achieves the fibers as described herein.

A fruit or vegetable byproduct may be obtained from any fruit or vegetable process that results in one or more portions of the fruit or vegetable that is typically removed as undesirable. As noted above, the byproduct may comprise at least one of a plurality of components, for example and without limitation peel, core, rag, seeds, rind, pomace, sensible solids, sinking solids, vesicles, finisher-derived solids, clarification filtration retentate, pulp, sacs, pericarp, membranes, cellulosic materials, and combinations thereof. The particle size of the fruit or vegetable byproduct will vary depending on the particular type of byproduct, for instance peel and core byproducts will be significantly larger than clarification filtration retentate or finisher-derived solids. The byproduct particle size is reduced according to aspects of the invention using any suitable means, typically one or more physical means disclosed herein as suitable for breaking plant cell walls; namely for example and without limitation, cutting, shredding, slicing, grinding, shearing, extruding, homogenizing, pulverizing, comminuting, subjecting to cavitation (e.g., via ultrasonic frequency), pressurizing, and combinations thereof.

According to certain embodiments, the reduced particle size of the fruit or vegetable byproduct comprises a diameter in at least one dimension of between about 1 μm and about 50 cm, or between about 0.1 mm and about 1 cm, or between about 0.01 mm and about 1 mm, or between about 1 mm and about 5 mm. Accordingly, certain fruit or vegetable byproducts will not require further processing to fall within a desired range of particle sizes. Additionally, it is known that particle sizes less than 0.005-0.01 millimeters are not detectable by the tongue and the particles feel slippery similar to fat. Further modification of the particle sizes through physical means could increase the fraction of small particles, which would be more easily suspended in a liquid product and not be detectable as a gritty fiber.

The byproduct particles are optionally combined with a liquid to form a slurry for extraction of components from the particles. The weight ratio of byproduct particles to liquid may range between about 1:99 to about 3:1, or about 1:50 to about 3:1, or about 1:25 to about 3:1, or about 1:10 to about 2:1, or about 1:4 to about 2:1, or about 1:2 to about 1:1, or about 1:2 to about 2:1. In certain embodiments, more than one fraction of liquid may be combined with the byproduct particles in a sequential extraction process.

Fruit and vegetable byproducts typically contain one or more naturally-occurring enzymes, which may optionally be deactivated to prevent undesired degradation of components within the byproduct and liquid byproduct extract. Any suitable method of deactivation may be employed as known to one of skill in the art, such as heating the particles or slurry to a temperature sufficient to deactivate the one or more enzymes. Following any heating of the particles or slurry, the particles or slurry may then be cooled to prevent heat-induced damage to any of the other components of the particles or slurry.

In embodiments of the invention, one or more select enzymes are added to the byproduct particles or slurry to hydrolyze or degrade at least one type of fiber extracted from within the byproduct cell walls. Suitable enzymes comprise enzymes that target specific fibers and thereby result in one or more predetermined ranges of average molecular weights for the specific fibers. According to certain aspects, more than one enzyme is included in the particles or slurry, wherein each enzyme hydrolyzes one or more types of fiber to a different average molecular weight range. Such combinations of enzymes advantageously provide the capability for generating blends of particular desired soluble and low molecular weight fibers that have distinct health benefits. In certain embodiments, the hydrolyzed fiber comprises a molecular weight of 5000 grams/mole (g/mol) or higher, such as between about 5000 g/mol and about 8000 g/mol, or between about 5000 g/mol and about 7000 g/mol, or between about 5000 g/mol and about 6000 g/mol, or between about 5200 g/mol and about 7700 g/mol, or between about 5500 g/mol and about 7500 g/mol, or between about 5700 g/mol and about 7000 g/mol, or between about 5500 g/mol and about 8000 g/mol, or between about 6500 g/mol and about 8000 g/mol.

For prebiotic oligosaccharides, in contrast, the molecular weight may be between about 300 g/mol and about 2500 g/mol, or between about 400 g/mol and about 2200 g/mol, or between about 500 g/mol and about 2000 g/mol, or between about 700 g/mol and about 1800 g/mol, or between about 900 g/mol and about 1600 g/mol, or between about 1000 g/mol and about 1400 g/mol, or between about 300 g/mol and about 800 g/mol, or between about 300 g/mol and about 1200 g/mol, or between about 300 g/mol and about 1500 g/mol, or between about 500 g/mol and about 1000 g/mol, or between about 600 g/mol and about 2500 g/mol, or between about 800 g/mol and about 2500 g/mol, or between about 1000 g/mol and about 2500 g/mol. Advantageously, a mixture of oligosaccharides and higher molecular weight polysaccharides will provide an optimal fermentation pattern in the human colon. Examples of suitable enzymes include for instance and without limitation, pectinase enzymes, cellulose enzymes, glycoside hydrolases, polysaccharide lyases, carbohydrate esterases, hemicellulase enzymes endocellulase enzymes, exocellulase enzymes, cellobiase enzymes, cellulose phosphorylase enzymes, enzymes from the Lyases family, and combinations thereof.

For instance, a typical enzyme is pectinase, added at a very mild concentration, such as on the order of between about 20 ppm and about 30 ppm (i.e., milligrams per liter). Usually, the one or more enzymes is present within the byproduct slurry for about 15 to about 60 minutes and at a temperature of up to about 120 degrees Fahrenheit (about 50 degrees Celsius). Such an enzyme treatment is useful in breaking down pectin and to function as a processing aid.

To break the plant cell walls and increase the amount of nutritional components released from within the cells of the fruit or vegetable byproduct, physical methods are particularly suitable, at least because physical methods typically result in products that may be considered natural, as opposed to products that have been subjected to chemical processing. As discussed above, suitable physical methods for breaking cell walls of the fruit or vegetable byproduct include for example and without limitation, cutting, shredding, slicing, grinding, shearing, extruding, homogenizing, pulverizing, comminuting, subjecting to cavitation, pressurizing, heating, subjecting to pulsed electric field processing, and combinations thereof. As noted above, subjecting to cavitation includes, for example and without limitation, subjecting to cavitation via ultrasonic frequency, vacuum cycle nucleation, hydrodynamic cavitation, cavitation via an external transducer, and combinations thereof. Suitable particle size reduction equipment is commercially available from such manufacturers as Korenco, Admix Inc. and Silverson.

According to embodiments of the invention, a single physical method is employed to break the plant cell walls. According to certain embodiments of the invention, two or more physical methods are combined, such as heating, subjecting to cavitation via ultrasonic frequency, grinding, and pressurizing. In certain aspects, the fruit or vegetable byproduct is sequentially subjected to different physical methods. The yield of soluble solids extracted from the byproduct may be increased by heating to raise the temperature of the byproduct particles or slurry above ambient temperature. The upper temperature limit may be selected depending on the heat sensitivity of one or more components in the slurry or byproduct particles, for instance an enzyme. In certain embodiments, the temperature of the heated particles or slurry is not greater than about 120 degrees Fahrenheit (about 50 degrees Celsius). When the particles or the slurry do not contain heat-sensitive components, the particles or slurry may be heated to a temperature of up to near boiling, for instance about 208 degrees Fahrenheit (about 98 degrees Celsius).

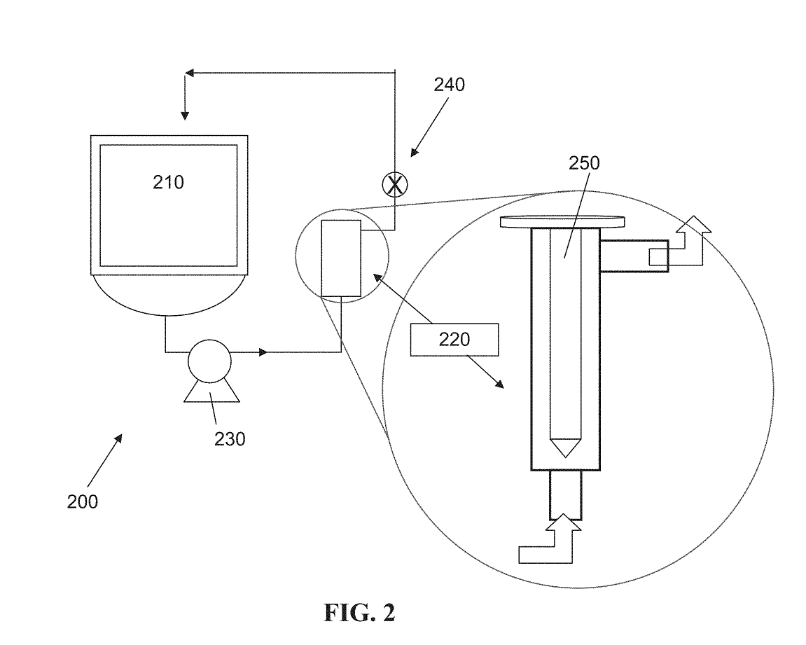

Referring to FIG. 2, a sample apparatus 200 is shown for extraction of nutrients from an orange peel fruit byproduct. The apparatus comprises a jacketed kettle 210 for heating and mixing the byproduct particles or particle slurry, a sonotrode unit housing 220 for providing ultrasonic frequencies, a pump 230 for circulating the byproduct particles or particle slurry between the jacketed kettle 210 and the sonotrode housing 220, and a needle valve 240 for adjusting the amount of back pressure applied to the system. The sonotrode 250 may be either radial or axial in design.

For extraction of nutrients on a commercial scale, according to certain embodiments of the invention, a hydrodynamic cavitation device may be employed. For instance, a device may be employed that is similar to the hydrodynamic cavitation device described in Mancosky U.S. Pat. Application Publication No. 2009/01836383 directed to the extraction of sugar, starch and/or carbohydrates from feed materials. Such a device subjects the byproduct particles or slurry to shockwaves from cavitation events within a cavitation reactor.

After the enzymatic degradation of fiber in the byproduct extract, large solids are removed from the byproduct particles or slurry by employing a filter. The resulting permeate comprises the soluble extracted nutrients as well as small insoluble components suspended in the liquid. Optionally, the liquid is then pasteurized, which not only microbially stabilizes the liquid but also deactivates the one or more added enzymes in the liquid permeate. If desired, the pasteurized liquid may be used as an additive to a comestible to provide low molecular weight fiber, prebiotic fiber, and combinations thereof, as well as the various other nutrients extracted from the fruit or vegetable byproduct. In embodiments of the invention, the fiber is isolated from the permeate liquid, for example by freeze-drying.

The use of a micro or ultra filtration unit may be used to isolate a desired molecular weight fraction of fiber. A typical ultra filtration membrane of this type will have a minimum pore size of about 0.005 microns, which generally equates to a Molecular Weight Cut Off (MWCO) of about 1000 g/mol. A typical ultra filtration membrane maximum pore size is about 0.1 microns, which generally equates to 500,000 MWCO. A typical microfiltration membrane of this type will have a pore size range of between about 0.1 micron and about 3.0 microns, preferably between about 0.3 microns and about 3.0 microns.

Examples of some suitable soluble fibers for targeting with extraction and degradation processes disclosed herein include for example and without limitation, galacto-oligosaccharides, pectic and arabinoxylo oligosaccharides, resistant starch, xyloglucans, glucuronoxylans, and combinations thereof.

Comestibles in which the fiber extracted from fruit or vegetable byproducts are included are not particularly limited. Examples of suitable comestibles include for instance and without limitation, a beverage, a soup, a spread, a pudding, a smoothie, a snack food, and a cereal. Advantages of incorporating the inventive low molecular weight fiber according to embodiments include providing a beneficial fermentation pattern in the colon, such as provided by a prebiotic fiber. Moreover, further advantages include the addition of fiber without a concomitant significant increase in viscosity of the comestible, as well as increased satiety provided from consumption of the comestible. Processes according to aspects of the invention further result in fiber that may be considered naturally obtained, thereby allowing a comestible to be labeled as 100% natural. The addition of the low molecular weight fiber makes use of more of the entire fruit or vegetable from which it is derived than previously employed.

Beverage products disclosed here include beverages, i.e., ready to drink liquid formulations, beverage concentrates and the like. Beverages include, e.g., carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sport drinks, and alcoholic products. The terms “beverage concentrate” and “syrup” are used interchangeably throughout this disclosure. At least certain exemplary embodiments of the beverage concentrates contemplated are prepared with an initial volume of water to which the additional ingredients are added. Full strength beverage compositions can be formed from the beverage concentrate by adding further volumes of water to the concentrate. Typically, for example, full strength beverages can be prepared from the concentrates by combining approximately 1 part concentrate with between approximately 3 to approximately 7 parts water. In certain exemplary embodiments the full strength beverage is prepared by combining 1 part concentrate with 5 parts water. In certain exemplary embodiments the additional water used to form the full strength beverages is carbonated water. In certain other embodiments, a full strength beverage is directly prepared without the formation of a concentrate and subsequent dilution.

Not from concentrate, or NFC, juices tend to be popular with consumers for numerous reasons, such as their fresh taste and nutritional profile. These NFC juices must meet particular standard of identity criteria. Among these criteria are brix minimums and brix-to-acid ratio minimums. For example, the US Food and Drug Administration sets a standard for juices such as orange juice. In this regard 21 CFR Section 146.140, incorporated by reference hereinto, states that finished pasteurized orange juice is to contain not less than 10.5 percent by weight of orange juice soluble solids, exclusive of the solids of any added sweetening ingredients. This FDA regulation further states that the ratio of brix to grams of citric acid per 100 ml of juice is not less than a 10 to 1 ratio. The juice industry recognizes these criteria for pasteurized orange juice or single strength orange juice as applying to NFC orange juice. It will be understood that these standard of identity criteria are used herein with respect to NFC orange juice or pasteurized single strength orange juice. This same concept of standard of identity criteria applies as well to other pasteurized single strength juices. In certain embodiments of the invention, NFC juices comprising extracted fiber obtained from the same fruit or vegetable as the NFC juice is added to the NFC juice without affecting the standard of identify of the NFC juice.

Similarly, the US Food and Drug Administration sets a standard for food labeling, including juice labeling. 21 CFR Section 101.30 states that beverages containing “100 percent juice and non-juice ingredients that do not result in a diminution of the juice soluble solids or, in the case of expressed juice, in a change in the volume, when the 100 percent juice declaration appears on a panel of the label that does not also bear the ingredient statement, it must be accompanied by the phrase “with added ______,” the blank filled in with a term such as “ingredient(s),” “preservative,” or “sweetener,” as appropriate (e.g., “100% juice with added sweetener”), except that when the presence of the non-juice ingredient(s) is declared as a part of the statement of identity of the product, this phrase need not accompany the 100 percent juice declaration.” Consequently, fiber derived from fruit or vegetables are ingredients included within the standard of identity of juice, the juice beverages of certain embodiments of the invention may be labeled as “100 percent juice.”

In alternative embodiments, juice beverages may be prepared that are not 100% juice. For example, juice beverages may comprise from concentrate (FC) juice, which is juice that has been previously concentrated to remove water, and then diluted to provide at least a minimum specified Brix, depending on the type of juice. Orange juice, for instance, must have a minimum Brix level of 11.8, while grapefruit juice must have a minimum Brix level of 10.0. Further embodiments include juice beverages comprising reduced calorie, light, or low-calorie juice. Such beverages typically comprise juice, added water, and often other added ingredients to provide a desired taste, such as non-nutritive sweeteners. The inclusion of the fiber can result in a greater feeling of satiety following consumption of the food or beverage product, as compared to the product without the added fiber.

It should be understood that juice beverages and other food or beverage products in accordance with this disclosure may have any of numerous different specific formulations or constitutions. In general, an NFC and/or 100% juice beverage in accordance with this disclosure typically comprises juice and fiber extracted from fruit or vegetable byproducts. The formulation of a beverage product in accordance with this disclosure can vary to a certain extent, depending upon such factors as the product's intended market segment, its desired nutritional characteristics, flavor profile and the like.

For example, it will generally be an option to add further ingredients to the formulation of a particular beverage embodiment, including any beverage formulations described below in particular if the beverage is not required to meet a specific standard of identity. Additional (i.e., more and/or other) sweeteners may be added, flavorings, inclusions (e.g., fruit pieces, fiber, oat flour or nuts), electrolytes, vitamins, tastants, masking agents and the like, flavor enhancers, and/or carbonation typically can be added to any such formulations to vary the taste, mouthfeel, nutritional characteristics, etc.

In certain embodiments, juice is a basic ingredient in beverages disclosed here, typically being the vehicle or primary liquid portion in which the remaining ingredients are dissolved, emulsified, suspended or dispersed. Juices suitable for use in at least certain exemplary embodiments of the beverage products disclosed here include, e.g., fruit, vegetable and berry juices. Juices can be employed in the present invention in the form of a single-strength juice, NFC juice, 100% pure juice, juice concentrate, juice puree, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a beverage having the desired flavor.

Examples of suitable juice sources include orange, lemon, lime, tangerine, mandarin orange, tangelo, pomelo, grapefruit, grape, red grape, sweet potato, tomato, celery, beet, lettuce, spinach, cabbage, watercress, rhubarb, carrot, cucumber, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, lychee, plum, prune, date, currant, cashew apple, fig, etc. Numerous additional and alternative juices suitable for use in at least certain exemplary embodiments will be apparent to those skilled in the art given the benefit of this disclosure.

In embodiments for which the juice beverage is not 100% juice or is from concentrate, water may instead be the vehicle or primary liquid portion in which the remaining ingredients are included. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain embodiments, water is present at a level of from about 1% to about 99.9% by weight of the beverage. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

Acid used in food or beverage products disclosed here can serve any one or more of several functions, including, for example, providing antioxidant activity, lending tartness to the taste of the beverage, enhancing palatability, increasing thirst quenching effect, modifying sweetness and acting as a mild preservative by providing microbiological stability. Ascorbic acid, commonly referred to as “vitamin C”, is often employed as an acidulant in beverages to also provide a vitamin to the consumer. Any suitable edible acid may be used, for example citric acid, malic acid, tartaric acid, phosphoric acid, ascorbic acid, lactic acid, formic acid, fumaric acid, gluconic acid, succinic acid and/or adipic acid.

The acid can be used in solid or solution form, and in an amount sufficient to provide the desired pH of the food or beverage product. Typically, for example, the one or more acids of the acidulant are used in amount, collectively, of from about 0.01% to about 1.0% by weight of the product, e.g., from about 0.05% to about 0.5% by weight of the product, such as 0.1% to 0.25% by weight of the product, depending upon the acidulant used, desired pH, other ingredients used, etc.

The pH of at least certain exemplary embodiments of food or beverage products disclosed here can be a value within the range of 2.5 to 4.6. The acid in certain exemplary embodiments can enhance flavor. Too much acid can impair the beverage flavor and result in sourness or other off-taste, while too little acid can make a beverage, for example, taste flat and reduce microbiological safety of the product. Alternatively, the pH of at least certain exemplary embodiments of food or beverage products disclosed here can be a value greater than 4.6, such as for dairy products or vegetable juices. It will be within the ability of those skilled in the art, given the benefit of this disclosure, to select a suitable acid or combination of acids and the amounts of such acids for the acidulant component of any particular embodiment of the food or beverage products disclosed here.

Certain exemplary embodiments of the comestible products disclosed here also may contain small amounts of alkaline agents to adjust pH. Such agents include, e.g., potassium hydroxide, sodium hydroxide and potassium carbonate. For example, the alkaline agent potassium hydroxide may be used in an amount of from about 0.02 to about 0.04% by weight, with an amount of about 0.03% being typical for certain comestibles. The amount will depend, of course, on the type of alkaline agents and on the degree to which the pH is to be adjusted.

Sweeteners suitable for use in various embodiments of the food or beverage products disclosed here include nutritive and non-nutritive, natural and artificial or synthetic sweeteners. In at least certain exemplary embodiments disclosed here, the sweetener component can include nutritive, natural crystalline or liquid sweeteners such as sucrose, liquid sucrose, fructose, liquid fructose, glucose, liquid glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, Lo Han Guo juice concentrate and/or others. Typically, such sweeteners are present in an amount of from about 0.1% to about 20% by weight of a finished beverage, such as from about 6% to about 16% by weight, depending upon the desired level of sweetness for the beverage. To achieve desired beverage uniformity, texture and taste, in certain exemplary embodiments of the natural beverage products disclosed here, standardized liquid sugars as are commonly employed in the beverage industry can be used. Typically such standardized sweeteners are free of traces of nonsugar solids which could adversely affect the flavor, color or consistency of the beverage.

Suitable non-nutritive sweeteners and combinations of sweeteners are selected for the desired nutritional characteristics, taste profile for the beverage, mouthfeel and other organoleptic factors. Non-nutritive sweeteners suitable for at least certain exemplary embodiments include, but are not limited to, for example, peptide based sweeteners, e.g., aspartame, neotame, and alitame, and non-peptide based sweeteners, for example, sodium saccharin, calcium saccharin, acesulfame potassium, sodium cyclamate, calcium cyclamate, neohesperidin dihydrochalcone, and sucralose. In certain embodiments the sweetener comprises acesulfame potassium. Other non-nutritive sweeteners suitable for at least certain exemplary embodiments include, for example, Stevia rebaudiana extracts, rebaudioside A, rebaudioside B, rebaudioside C, rebaudioside D, rebaudioside E, rebaudioside F, sorbitol, mannitol, xylitol, glycyrrhizin, D-tagatose, erythritol, meso-erythritol, maltitol, maltose, lactose, fructo-oligosaccharides, Lo Han Guo powder, xylose, arabinose, isomalt, lactitol, maltitol, trehalose, and ribose, and protein sweeteners such as thaumatin, monellin, brazzein, L-alanine and glycine, related compounds, and mixtures of any of them. Lo Han Guo, Stevia rebaudiana extracts, rebaudioside A, and monatin and related compounds are natural non-nutritive potent sweeteners.

Non-nutritive, high potency sweeteners typically are employed at a level of milligrams per fluid ounce of a beverage, according to their sweetening power, any applicable regulatory provisions of the country where the beverage is to be marketed, the desired level of sweetness of the beverage, etc. It will be within the ability of those skilled in the art, given the benefit of this disclosure, to select suitable additional or alternative sweeteners for use in various embodiments of the beverage products disclosed here.

Preservatives may be used in certain embodiments of beverages disclosed here. That is, certain exemplary embodiments contain an optional dissolved preservative system. Furthermore, embodiments of beverages having low acidity generally comprise a preservative system. If a preservative system is used, it can be added to the food or beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoic acid, benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), lauryl arginate ester, cinnamic acid, e.g., sodium and potassium cinnamates, polylysine, and antimicrobial essential oils, dimethyl dicarbonate, and mixtures thereof, and antioxidants such as ascorbic acid, EDTA, BHA, BHT, TBHQ, EMIQ, dehydroacetic acid, ethoxyquin, heptylparaben, and combinations thereof.

Preservatives can be used in amounts not exceeding mandated maximum levels under applicable laws and regulations. The level of preservative used typically is adjusted according to the planned final product pH, as well as an evaluation of the microbiological spoilage potential of the particular food or beverage formulation. The maximum level employed typically is about 0.05% by weight of the beverage. It will be within the ability of those skilled in the art, given the benefit of this disclosure, to select a suitable preservative or combination of preservatives for beverages according to this disclosure.

Other methods of beverage preservation suitable for at least certain exemplary embodiments of the food and beverage products disclosed here, such as ready-to-drink beverages, include, e.g., aseptic packaging and/or heat treatment or thermal processing steps, such as hot filling and tunnel pasteurization. Such steps can be used to reduce yeast, mold and microbial growth in the food and beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate. In general, heat treatment includes hot fill methods typically using high temperatures for a short time, e.g., about 190° F. for 30 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

The food or beverage products disclosed here optionally contain a flavoring composition, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but that are commonly accepted as a berry. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime and grapefruit, and such flavors as apple, pomegranate, grape, cherry, and pineapple flavors and the like, and mixtures thereof. In certain exemplary embodiments beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component can further comprise a blend of the above-mentioned flavors. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Other flavorings suitable for use in at least certain exemplary embodiments of the food or beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide can be used to provide effervescence to certain exemplary embodiments of beverage products disclosed here, such as ready to drink juice beverages, frozen slush beverages or fountain beverages. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage has a CO₂ level up to about 7.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of water at 60° F. (16° C.) temperature and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage. The carbonation can be natural or synthetic.

The food or beverage products disclosed here may contain additional ingredients, including, generally, any of those typically found in food or beverage formulations. Examples of such additional ingredients include, but are not limited to, salt, caffeine, caramel and other coloring agents or dyes, antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B₁ (thiamine), B₂ (riboflavin), B₃ (nicotinamide), B₄ (adenine), B₅ (pantothenic acid, calcium), B₆ (pyridoxine HCl), B₁₂ (cyanocobalamin), and K₁ (phylloquinone), niacin, folic acid, biotin, and combinations thereof. The optional non-mineral nutritional supplements are typically present in amounts generally accepted under good manufacturing practices. Exemplary amounts are between about 1% and about 100% RDV, where such RDV are established. In certain exemplary embodiments the non-mineral nutritional supplement ingredient(s) are present in an amount of from about 5% to about 20% RDV, where established.

### EXAMPLES

### Example 1

Orange peel was evaluated as a source of fiber and potentially for possible use as a prebiotic. Experiments were conducted using cavitation via ultrasonic sound waves to break down cell wall material, with subsequent treatment with pectinase and cellulase enzymes to decrease the molecular weight, and further cavitation via ultrasound.

Orange peel from Early Hamlin orange variety was shredded with a Korenco shredder. The shredded peel was diluted with water at a weight ratio of 2:1 water to shredded peel to form a slurry, then the slurry was added to the jacketed kettle of an apparatus according to FIG. 2. The experimental batch size was approximately 450 pounds of slurry. The ultrasound probe was attached to a 1000 W generator, supplied by Cavitus (Crafers, SA, Australia).

There were two enzyme experiments conducted at two different temperatures. Enzymes used in the experiment were obtained from Danisco (Copenhagen, Denmark) and were Laminex C2K Cellulase and Grindamyl CA 150 Pectinase added in an amount of 200 ppm and 100 ppm, respectively. Two temperatures were used with identical concentrations of enzymes; experiments were conducted at 104 degrees Fahrenheit (40 degrees Celsius), and 120 degrees Fahrenheit (48 degrees Celsius), to determine if the higher temperatures would result in deactivation of the enzymes, for a total of four enzyme experiments. The slurry was heated to 180 degrees Fahrenheit to inactivate pectin methyl esterase (PME). Following heating, the slurry was cooled to either 104 degrees Fahrenheit or 120 degrees Fahrenheit, at which time the batch was pumped through the sonotrode and recirculated back into the tank. The enzyme was added and the mixture was allowed to mix in the jacketed kettle for one hour, at which time a sample was extracted. The mixture was then sonicated once again after enzyme treatment and another sample was taken. From the subsequent analytical results, the process conditions did not inactivate the added enzymes. The experimental design and results are shown in Table 1 below.

For all experiments, the sample was filtered through a 20 mesh screen and the solids versus the liquid (i.e., a suspension of insoluble material and soluble solids) were separately frozen. Two controls were sampled after dilution and heat treatment, but before cavitation via ultrasound or enzyme treatment.

TABLE 1
Example 1 experimental design and results
Orange Peel Processing with Cavitation via Ultrasound and Enzymes

| | | Flow | | Power | | | Apparent | Apparent |
|---|---|---|---|---|---|---|---|---|
| | Pump | Rate in | Back | (Watts) | | | Viscosity | Viscosity |
| | Power | gallons/ | Pressure | on US | Temp | % | Liquid, | “as is”, |
| Sample | Setting | minute | PSI | Probe | F. | Solids | cp** | cp** |
| Control 1 | | | 0 | | | 3.97 | 190 | 6140 |
| No | | | | | | | | |
| Treatment | | | | | | | | |
| Control 2 | 50 | 5.8 | 0 | 0 | 155 | 3.58 | 20 | 730 |
| No | | | | | | | | |
| Treatment | | | | | | | | |
| E1 | 50 | 5.8 | 0 | 680 | 104 | 5.13 | 86 | 1600 |
| E2 | 50 | 5.8 | 0 | 680 | 104 | 5.17 | 142 | 1375 |
| E3 | 50 | 5.8 | 0 | 681 | 120 | 5.55 | 43 | 1500 |
| E4 | 50 | 5.8 | 0 | 680 | 120 | 5.27 | 82 | 2000 |

*Brookfield LV Viscometer used to measure viscosity

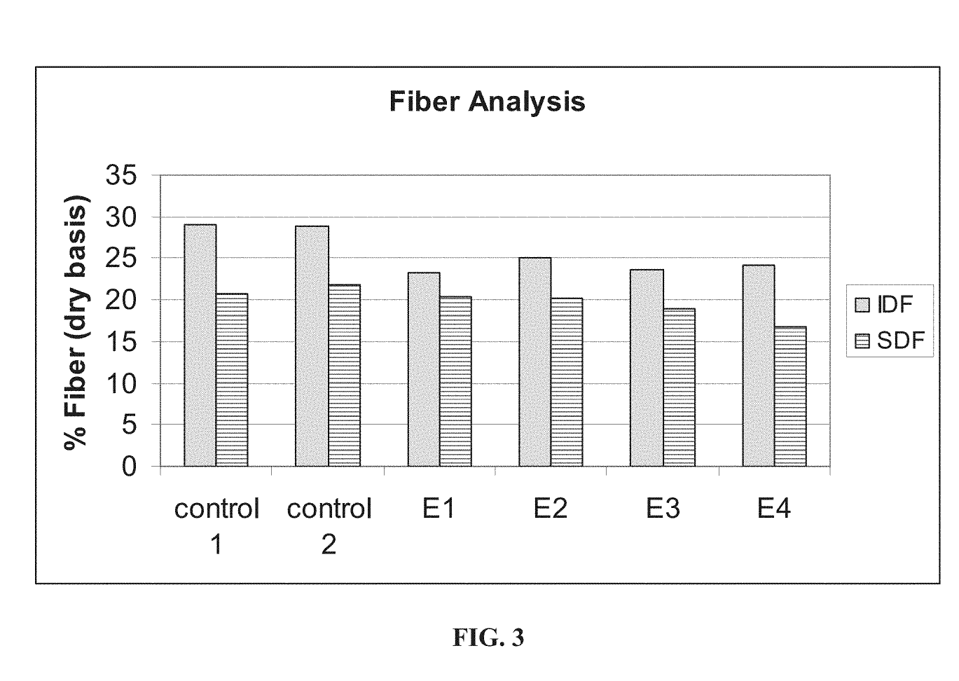

Referring to FIG. 3, pilot plant scale experiments showed that cell wall polysaccharides were solubilized with cavitation via ultrasound and enzyme treatment as shown as a decrease in both soluble fiber and insoluble fiber. Increasing the intensity of the treatment by increasing residence time and/or backpressure, further increased fiber degradation. Increasing hydrostatic pressure raises the cavitation threshold of the slurry, however it also causes the implosions of the cavitation bubbles to be stronger and thus more energy is released during the process. Enzymic hydrolysis was also enhanced with the ultrasound treatment. The fiber analysis presented in Table 1 and FIG. 3 shows that enzymes clearly reduce total dietary fiber (TDF), which is the sum of insoluble dietary fiber (IDF) and soluble dietary fiber (SDF). The results suggest that cavitation via ultrasound may also aid in increasing the activity of enzymes to hydrolyze polysaccharides into lower molecular weight material. One proposed mechanism is that the increased surface area with which the enzymes can act to hydrolyze fiber results in greater enzyme hydrolysis of the extracted fiber.

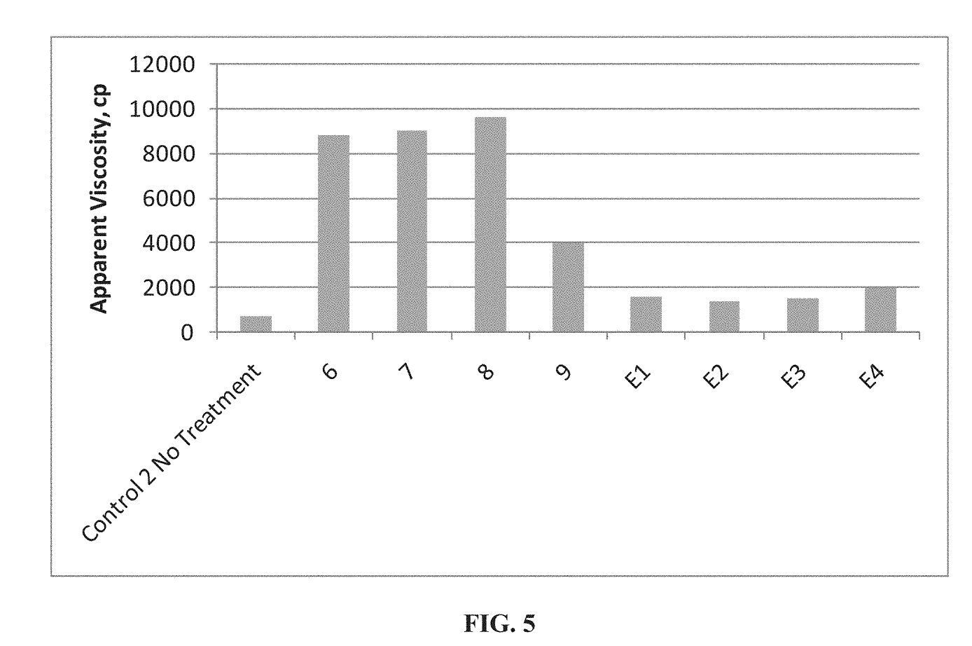

Referring to FIG. 5 and Table 1, viscosity readings were taken on the liquid samples, as well as on the samples prior to passing the mixture through a 20 mesh screen, using a Brookfield LVT viscometer and various spindles. Viscosity was very difficult to measure as chunky mixtures typically give poor results, however viscosity measurements provided a real time analysis of results as an alternative to fiber analysis (which often takes two days to complete). The solids in the mixtures were evident in the Brookfield measurements as a high variation in values over time. Cavitation via ultrasound with enzymatic degradation decreases molecular weight, thus a decrease in viscosity was exhibited. This process may therefore incorporate cavitation via ultrasound or another process to break apart cell wall material by physical means, to allow enzymes to break down polysaccharides into less viscous material as well as prebiotic oligosaccharides.

### Example 2

Orange peel was evaluated as a source of fiber and potentially for possible use as a prebiotic. Experiments were conducted using cavitation via ultrasonic sound waves to break down cell wall material.

Orange peel from Early Hamlin orange variety was shredded with a Korenco shredder. The shredded peel was diluted with water at a weight ratio of 2:1 water to shredded peel to form a slurry, then the slurry was added to the jacketed kettle of an apparatus according to FIG. 2. The experimental batch size was approximately 450 pounds of slurry. The ultrasound probe was attached to a 1000 W generator, supplied by Cavitus (Crafers, SA, Australia).

The experiments were conducted at two different temperatures; at 120 degrees Fahrenheit (40 degrees Celsius), and at about 145 degrees Fahrenheit (48 degrees Celsius), for a total of four experiments. The slurry was heated to 180 degrees Fahrenheit to inactivate pectin methyl esterase (PME). Following heating, the slurry was cooled to either 120 degrees Fahrenheit or 145 degrees Fahrenheit, at which time the batch was pumped through the sonotrode and recirculated back into the tank. The backpressure in the apparatus was varied from 5 psi up to 10 psi. The experimental design and results are shown in Table 2 below.

For all experiments, the sample was filtered through a 20 mesh screen and the solids versus the liquid (i.e., a suspension of insoluble material and soluble solids) were separately frozen. The experiments included the same two controls from Example 1.

TABLE 2
Example 2 experimental design and results
Orange Peel Processing with Cavitation via Ultrasound

| | | Flow | | Power | | | | |
|---|---|---|---|---|---|---|---|---|
| | Pump | Rate in | Back | (Watts) | | | Apparent | Apparent |
| | Power | gallons/ | Pressure | on US | Temp | % | Viscosity | Viscosity |
| Sample | Setting | minute | PSI | Probe | F. | Solids | Liquid, cp* | “as is”, cp* |
| Control 1 | | | 0 | | | 3.97 | 190 | 6140 |
| No | | | | | | | | |
| Treatment | | | | | | | | |
| Control 2 | 50 | 5.8 | 0 | 0 | 155 | 3.58 | 20 | 730 |
| No | | | | | | | | |
| Treatment | | | | | | | | |
| 6 | 50 | 5.8 | 10 | 900 | 120 | 4.29 | 58 | 8800 |
| 7 | 75 | 9.8 | 6 | 880 | 145 | 4.31 | 80 | 9000 |
| 8 | 100 | 15 | 5 | 888 | 147 | 4.44 | 46 | 9600 |
| 9 | 50 | 5.8 | 7 | 880 | 147 | 4.39 | 78 | 4000 |

*Brookfield LV Viscometer used to measure viscosity

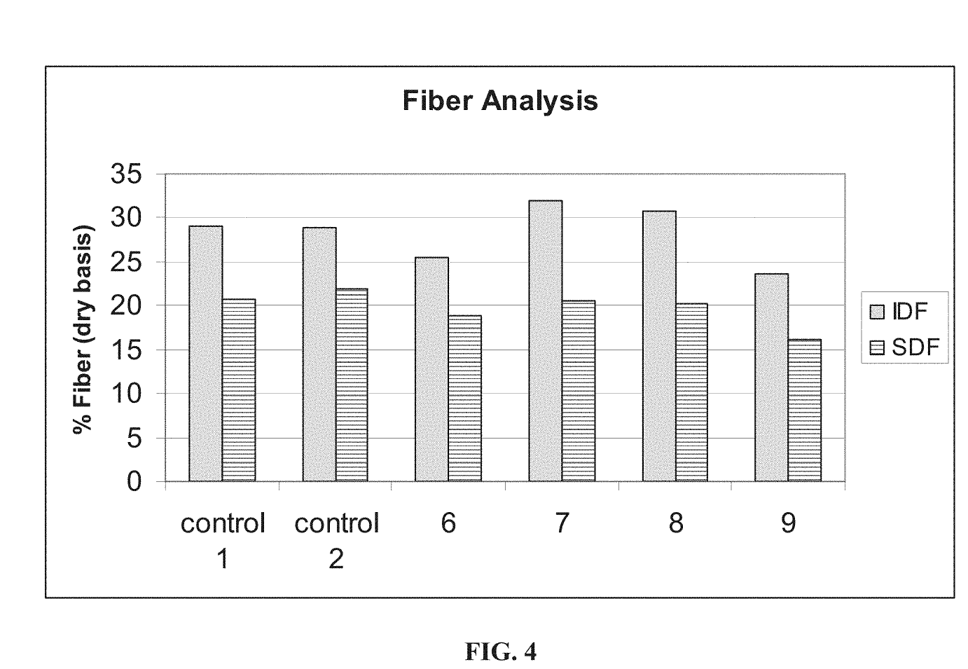

Referring to FIG. 4, pilot plant scale experiments showed that cell walls were broken with cavitation via ultrasound alone, as shown as a decrease in soluble fiber. Increasing the intensity of the treatment by increasing backpressure further increased fiber degradation. The fiber analysis presented in Table 1, Table 2, FIG. 3 and FIG. 4 shows differences between the different treatments, with enzymes clearly reducing total dietary fiber (TDF), which is the sum of insoluble dietary fiber (IDF) and soluble dietary fiber (SDF). Because all of the treatments decreased the amount of TDF and IDF, it is hypothesized that cavitation via ultrasonic treatment is breaking apart the cell wall material, and that adding backpressure to the reaction vessel increases the destruction.

### Comparative Example 3

Orange peel was evaluated as a source of fiber and potentially for possible use as a prebiotic. Experiments were conducted using cavitation via ultrasonic sound waves from an ultrasound probe in a stationary system, to break down cell wall material.

California Valencia oranges were obtained from Joe Caputo's (Palatine, Ill.) and juiced using an electric home appliance for this purpose. The peels were then shredded with a Korenco shredder to small pieces of approximately 2-4 mm in size. The shredded peel was mixed with two times by weight water and heated to 180 degrees Fahrenheit in a three gallon steel stock kettle. The peel was then cooled to 149 degrees Fahrenheit (65 degrees Celsius) and room temperature at 71.6 degrees Fahrenheit (22 degrees Celsius). A factorial experimental design was conducted with the variables of Table 3.

TABLE 3
Comparative Example 3 factorial experimental design

| | | |
|---|---|---|
| Temperature | 22 degrees C. | 65 degrees C. |
| Time | 10 seconds | 45 seconds |
| Ultrasound Probe | Radial | Axial |
| Type | | |
| Ultrasound Probe | 50% | 100% |
| Power | | |

The ultrasound probe was a 400 W unit, supplied by Cavitus (Crafers, SA, Australia). Each experiment was conducted in a 600 mL plastic beaker, with 250 mL of the 2:1 water:peel mixture. It is clear from the results that there was no real difference in treatments with cavitation via ultrasound. Consequently, it is hypothesized that a physical process more intense than provided by a 400 W ultrasound probe in a large plastic beaker, as a stationary system, is required to significantly result in cell wall breakage. The full experimental design and results are provided below in Table 4.

TABLE 4
Comparative Example 3 full experimental design and results

| | | | | | | % soluble | | |
|---|---|---|---|---|---|---|---|---|
| | | | | | % soluble | solids | | |
| | | | | | solids | after | | |
| | Temp | | % | Time | before | enzyme | % | % |
| Sample | (Celsius) | Probe | Power | (seconds) | enzyme | treatment | DP > 12 | DP < 12 |
| 1 | 65 | Axial | 100 | 45 | 12.00 | 17.97 | 1.77 | 5.50 |
| 2 | 65 | Axial | 50 | 45 | 12.00 | 18.09 | 1.59 | 5.58 |
| 3 | 65 | Axial | 100 | 45 | 12.12 | 17.67 | 1.55 | 5.34 |
| 4 | 65 | Radial | 100 | 45 | 12.09 | 18.15 | 1.58 | 5.07 |
| 5 | 65 | Radial | 100 | 45 | 12.09 | 18.21 | 1.76 | 5.68 |
| 6 | 65 | Radial | 50 | 45 | 12.00 | 18.24 | 1.21 | 5.71 |
| 7 | 65 | Radial | 100 | 10 | 12.09 | 18.21 | 1.40 | 5.55 |
| 8 | 65 | Radial | 100 | 10 | 12.12 | 18.63 | 1.56 | 5.97 |
| 9 | 65 | Radial | 50 | 10 | 12.12 | 18.36 | 1.18 | 5.83 |
| 10 | 65 | Axial | 100 | 10 | 12.15 | 18.42 | 1.13 | 5.96 |
| 11 | 65 | Axial | 100 | 10 | 12.15 | 18.6 | 1.27 | 5.98 |
| 12 | 65 | Axial | 50 | 10 | 12.18 | 18.27 | 1.23 | 5.93 |
| 13 | 65 | Axial | 50 | 10 | 12.42 | 18.54 | 1.26 | 5.82 |
| 14 | 65 | Control | | | 12.27 | 18.81 | 1.52 | 5.70 |
| 15 | RT | Axial | 50 | 45 | 11.55 | 17.94 | 1.15 | 5.75 |
| 16 | RT | Axial | 100 | 45 | 11.67 | 17.97 | 1.41 | 5.48 |
| 17 | RT | Radial | 100 | 45 | 11.67 | 18.27 | 1.52 | 5.65 |
| 18 | RT | Radial | 100 | 45 | 11.61 | 18.18 | 1.40 | 5.66 |
| 19 | RT | Radial | 50 | 45 | 11.64 | 17.67 | 1.18 | 5.93 |
| 20 | RT | Radial | 100 | 10 | 11.67 | 17.94 | 1.49 | 5.86 |
| 21 | RT | Radial | 100 | 10 | 11.67 | 17.88 | 1.76 | 5.60 |
| 22 | RT | Radial | 50 | 10 | 10.83 | 18.24 | 1.53 | 5.71 |
| 23 | RT | Axial | 100 | 10 | 11.70 | 17.85 | 1.34 | 5.64 |
| 24 | RT | Axial | 100 | 10 | 11.67 | 18.69 | 1.32 | 5.92 |
| 25 | RT | Axial | 50 | 10 | 11.67 | 18.48 | | |
| 26 | RT | Axial | 50 | 10 | 11.67 | 18.06 | 1.63 | 5.70 |
| 27 | RT | Control | | | 11.52 | 17.67 | 1.67 | 5.51 |
| 28 | RT | Axial | 100 | 45 | 11.55 | 17.82 | 1.71 | 5.48 |

Given the benefit of the above disclosure and description of exemplary embodiments, it will be apparent to those skilled in the art that numerous alternate and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

1.-9. (canceled)

10. A pectic oligosaccharide extracted from a fruit or vegetable byproduct comprising a molecular weight between about 300 g/mol and about 2500 g/mol.

11. The pectic oligosaccharide of claim 10, comprising a molecular weight between about 500 g/mol and about 2000 g/mol.

12. The pectic oligosaccharide of claim 10, comprising a molecular weight between about 300 g/mol and about 1200 g/mol.

13. The pectic oligosaccharide of claim 10, comprising a molecular weight between about 1000 g/mol and about 2500 g/mol.

14. The pectic oligosaccharide of claim 10, wherein the fruit or vegetable byproduct comprises orange peel, grapefruit peel, lemon peel, lime peel, or combinations thereof.

15. The pectic oligosaccharide of claim 10, wherein the oligosaccharide is extracted using one or more natural processes selected from the group consisting of heat treatment, enzymatic hydrolysis, cavitation, grinding, pressure, and combinations thereof.

16. The pectic oligosaccharide of claim 10, wherein the oligosaccharide is a prebiotic fiber.

17. A food or beverage comprising the pectic oligosaccharide of claim 10.

18. A beverage comprising the pectic oligosaccharide of claim 10, wherein the beverage meets the standard of identity of a 100% juice.

19. A method for producing a soluble fiber comprising:
reducing the particle size of a fruit or vegetable byproduct;
subjecting the byproduct particles to a physical process to break cell walls of the byproduct particle;
adding one or more enzymes to the byproduct particles;
mixing or agitating the byproduct particles; and
filtering the byproduct particles to provide a retentate and a permeate, wherein the permeate comprises the fiber.

20. The method of claim 19, further comprising combining the byproduct particles with a liquid to form a slurry directly following reducing the particle size of a fruit or vegetable byproduct.

21. The method of claim 20, further comprising heating the slurry to deactivate enzymes present in the byproduct particles and cooling the slurry, wherein the heating and cooling are performed prior to subjecting the byproduct particles to a physical process to break cell walls of the byproduct particles.

22. The method of claim 19, wherein the fruit or vegetable byproduct particles comprise a particle size between about 1 mm and about 5 mm.

23. The method of claim 20, wherein the fruit or vegetable byproduct particles and the liquid are combined in a weight ratio of between about 1:2 and about 2:1 fruit or vegetable byproduct particles to liquid.

24. The method of claim 21, wherein the cooling comprises cooling the slurry to a temperature between about 100 degrees Fahrenheit and about 150 degrees Fahrenheit.

25. The method of claim 19, wherein the subjection to a physical process comprises subjection to cavitation selected from the group consisting of cavitation via an external transducer, cavitation via a hydrodynamic reactor, cavitation via vacuum cycle nucleation, and cavitation via ultrasonic frequency by passing the byproduct particles past an ultrasound probe operating at an amplitude of between about 5 microns to about 150 microns.

26. The method of claim 25, wherein the method further comprises subjecting the byproduct particles to pressure during the subjection to cavitation via ultrasonic frequency.

27. The method of claim 19, wherein the one or more enzymes comprise a cellulase, a pectinase, a hemicellulase, an endocellulase, an exocellulase, a cellobiase, a cellulose phosphorylase, an enzyme from the Lyases family, or combinations thereof.

28. The method of claim 19, wherein the mixing or agitating the byproduct particles further comprises subjection to a pressure of between about 0 psi and about 15 psi.

29.-35. (canceled)

36. A comestible comprising pectic oligosaccharide extracted from a fruit or vegetable byproduct, wherein the pectic oligosaccharide comprises a molecular weight between about 300 g/mol and about 2500 g/mol.

37. The comestible of claim 36, wherein the pectic oligosaccharide comprises a molecular weight between about 300 g/mol and about 1200 g/mol.

38. The comestible of claim 36, wherein the pectic oligosaccharide comprises a molecular weight between about 1000 g/mol and about 2500 g/mol.

39. The comestible of claim 36, wherein the oligosaccharide is extracted from orange peel, grapefruit peel, lemon peel, lime peel or combinations thereof.

40. The comestible of claim 36, wherein the oligosaccharide is extracted using one or more natural processes selected from the group consisting of heat treatment, enzymatic hydrolysis, cavitation, grinding, pressure, and combinations thereof.

41. The comestible of claim 36, wherein the comestible is selected from the group consisting of a beverage, a soup, a spread, a pudding, a smoothie, a snack food and a cereal.

42. The comestible of claim 36, wherein the oligosaccharide is a prebiotic fiber.

43. The comestible of claim 36, wherein the oligosaccharide is extracted using only natural processes.

44. The comestible of claim 36, wherein the beverage meets the standard of identity of a 100% juice.
